(19) United States
(12) Patent Application Publication
(10) Pub. No.: US 2011/0232051 A1
(43) Pub. Date: Sep. 29, 2011

(54) SEAT BELT BUCKLE MECHANISM

(75) Inventor: Russell E. CARLTON, Clarkston, MI (US)

(73) Assignee: TK HOLDINGS INC.

(21) Appl. No.: 13/051,957

(22) Filed: Mar. 18, 2011

Related U.S. Application Data
(60) Provisional application No. 61/316,675, filed on Mar. 23, 2010.

(51) Int. Cl. B60R 22/00

(52) U.S. Cl. 24/593.1

(57) ABSTRACT

A seat belt system includes a tongue member, a latch member for detachably engaging the tongue member, a release member for releasing engagement between the tongue member and the latch member and a slide switch configured to communicate whether the tongue member is engaged with the latch member. The slide switch includes a sliding member configured to slide between first and second positions and a printed circuit board. The sliding member includes a first sliding contact member and a second sliding contact member. The printed circuit board includes a first printed circuit board contact member that contacts both the first and second sliding contact members when the sliding member is in the first position. When the sliding member moves from the first position to second position the first sliding contact member is configured to break contact with the first printed circuit board contact member before the second sliding contact member.

### CROSS-REFERENCE TO RELATED PATENT APPLICATIONS

This application claims priority to and the benefit of U.S. Provisional Application No. 61/316,675, filed Mar. 23, 2010. The foregoing provisional application is incorporated by reference in its entirety.

### BACKGROUND

The present application relates generally to the field of slide switches for use in seat belt buckle mechanisms. More specifically, the application relates to slide switches configured to operate under both low current and high current conditions.

A slide switch is a switch that slides. Conventional slide switches may be used to illuminate dash panel lamps and pass relatively large currents to inductive lamps. Generally, slide switches need to perform under low voltage and current operating conditions while surviving arcing and maintaining moderate resistance. Often, slide switches must use noble metal contacts to maintain low resistance and low contact force to avoid wear. Conventional slide switches do not accomplish all of these goals in a single contact interface.

A need exists for improved technology, including technology that addresses the above described disadvantages. For example, a need exists for a slide switch that can address the above described disadvantages in a single contact interface.

### SUMMARY

One disclosed embodiment relates to a seat belt system for use in a motor vehicle that comprises a tongue member, a latch member, a release member and a slide switch. The latch member is for detachably engaging the tongue member. The release member is for releasing engagement between the tongue member and the latch member. The slide switch is configured to communicate whether the tongue member is engaged with the latch member. The slide switch includes a sliding member configured to slide between first and second positions and a printed circuit board. The sliding member includes a first sliding contact member and a second sliding contact member. The printed circuit board includes a first printed circuit board contact member that contacts both the first and second sliding contact members when the sliding member is in the first position. When the sliding member moves from the first position to the second position the first sliding contact member is configured to break contact with the first printed circuit board contact member before the second sliding contact member.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages will become apparent from the following description, appended claims, and the accompanying exemplary embodiments shown in the drawings, which are briefly described below.

FIG. 1 is a perspective view of a motor vehicle.

FIG. 2 is a perspective view of a seat belt system having a seat belt buckle mechanism for use in a motor vehicle, such as the motor vehicle of FIG. 1.

FIG. 3 is a perspective view of a seat belt buckle mechanism.

FIG. 4 is a perspective view of the seat belt buckle mechanism of FIG. 3 with the cover removed.

FIG. 5 is another perspective view of the seat belt buckle mechanism of FIG. 3 with the cover removed.

FIG. 6 is a perspective view of a portion of the seat belt buckle mechanism of FIG. 3, illustrating a slide switch.

FIG. 7 is an exploded perspective view of the seat belt buckle mechanism of FIG. 6.

FIG. 8 is an exploded perspective of the slide switch of FIG. 6.

FIG. 9a is a front view of an exemplary embodiment of a slide switch, which corresponds to a buckle mechanism with the tongue member engaged or coupled to the latch member.

FIG. 9b is a top view of the slide switch of FIG. 9a.

FIG. 10a is a front view of the slide switch of FIG. 9a, which corresponds to a buckle mechanism with the tongue member engaged or coupled at the full-stroke position to the latch member.

FIG. 10b is a top view of the slide switch of FIG. 10a.

FIG. 11a is a front view of the slide switch of FIG. 9a, which corresponds to a buckle mechanism with the tongue member not engaged or decoupled to the latch member.

FIG. 11b is a top view of the slide switch of FIG. 11a.

FIG. 12a is a front view of the slide switch of FIG. 9a.

FIG. 12b is a top view of the slide switch of FIG. 12a.

FIG. 13a is a front view of the slide switch of FIG. 9a.

FIG. 13b is a top view of the slide switch of FIG. 13a.

FIG. 14a is a front view of another exemplary slide switch.

FIG. 14b is a top view of the slide switch of FIG. 14a.

FIG. 15 is a partial detail view of a slide switch.

FIG. 16a is a top view of an exemplary embodiment of a sliding member.

FIG. 16b is a front view of the sliding member of FIG. 16a.

FIG. 17a is a partial detail view of a slide switch.

FIG. 17b is a partial detail view of a slide switch.

FIG. 17c is a partial detail view of a slide switch.

FIG. 17d is a partial detail view of a slide switch.

FIG. 17e is a partial detail view of a slide switch.

### DETAILED DESCRIPTION

Presently preferred embodiments are illustrated in the drawings. An effort has been made to use the same or like reference numbers throughout the drawings to refer to the same or like parts. The application discloses seat belt buckle mechanisms comprising slide switches configured to include contact members with multiple contacts, whereby the multiple contacts may include more than one contact type, in which each contact may be used to operate under independent operating conditions. The multiple contacts of the contact member may be configured similarly or uniquely (e.g., shape, material, coating) to provide maximum contact performance under different switching and circuit conditions. Although the application generally refers to a buckle mechanism or seat belt buckle mechanism that is part of a seat belt system used in a motor vehicle, the buckle mechanism may be part of a seat belt system in any vehicle providing active occupant restraint.

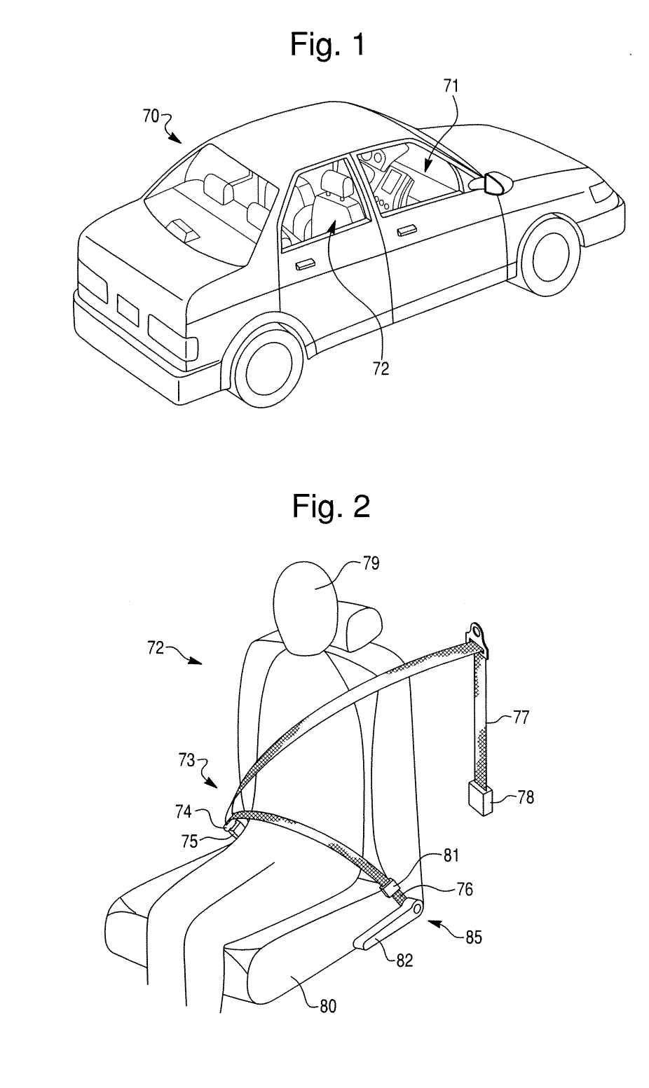

As shown in FIGS. 1-2, a motor vehicle 70 includes a passenger compartment 71 and a seat belt system 72 where an occupant 79 may sit on a seat cushion 80 of the seat belt system 72. The seat belt system 72 may include a seat belt mechanism 73, a tongue 74, a seat belt buckle mechanism 75, an anchor member 76, seat belt 77 and a retractor mechanism 78.

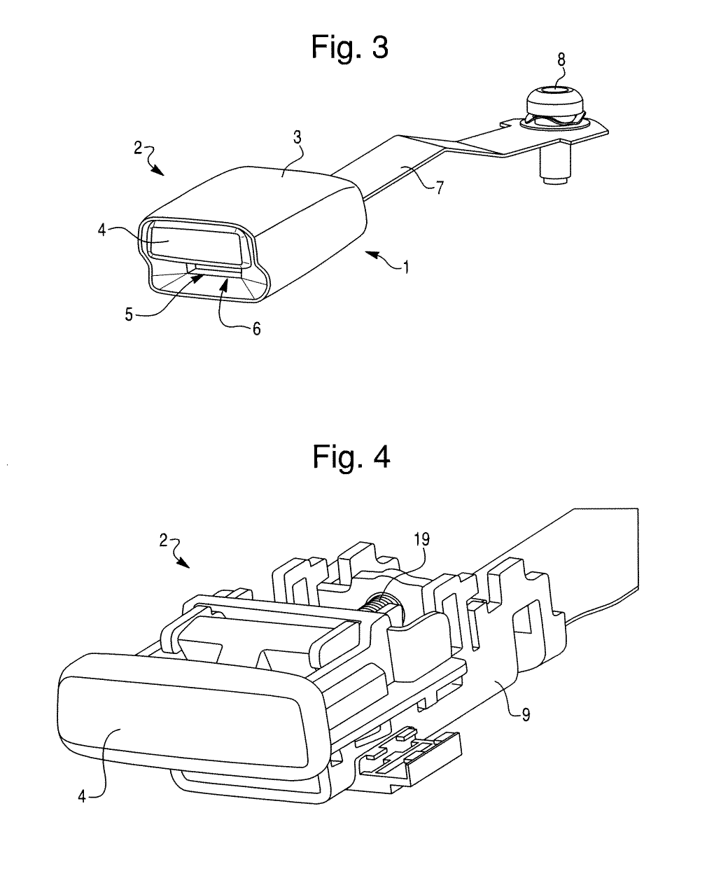

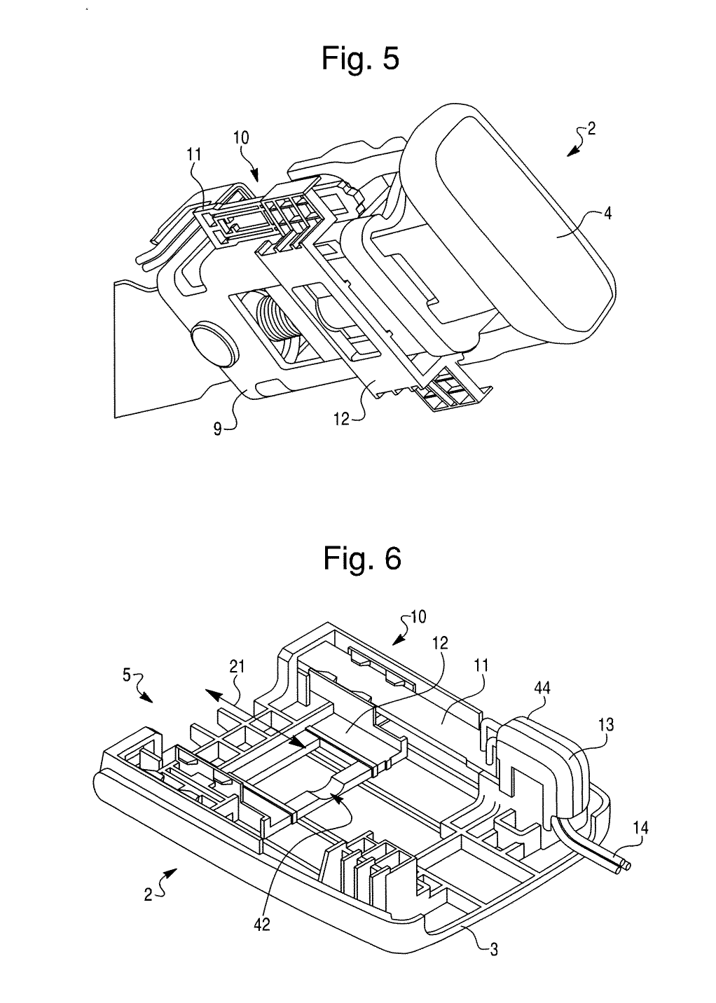

As shown in FIGS. 3-8, a seat belt buckle mechanism 2 includes a latch member 1 for detachably engaging a tongue member 74 or tongue 74 of a seat belt system 72, a frame or housing 9, a release button 4 for releasing engagement between the tongue member 74 and the latch member 1, a cover 3, a wiring harness 14, an actuator 12 and a slide switch 10 for communicating whether the tongue member 74 is engaged with the latch member 1.

The frame 9 may be made from an alloy (e.g., steel), a polymer, a composite, or any useful material and may couple to the anchor member 76 through any coupling method (e.g., fastener, weld, etc.).

The release button 4 may slideably couple to the frame 9. When depressed by an occupant 79, the release button 4 may displace relative to the frame 9, triggering release of the detachably coupled tongue member 74, in a direction opposite the tongue member insertion/engagement direction 5, from the latch member 1.

The cover 3 may include one or more portions that couple together to protect the buckle mechanism 2 and to provide aesthetics. The cover 3 may form an aperture 6 (FIG. 3) to receive the tongue member 74 of the seat belt system 72, where insertion of the tongue member 74 in the tongue member insertion/engagement direction 5 into the aperture 6 may engage buckling. When the tongue member 74 is retained by the latch member 1 and until the tongue member 74 is released, active restraint is provided to an occupant 79 restrained by the seat belt 77 attached to the tongue member 74.

The wiring harness 14 (FIG. 6) may be connected at a first end 44 to a dielectric 11 and at a second end to another vehicle component, such as a control module or indicator lamp. The wiring harness 14 may have more than two ends, which may be coupled to multiple vehicle components. Leads joining the wiring harness 14 to the dielectric 11 may be protected by a wiring lead cover 13. The wiring harness 14 may communicate the position (e.g., open, closed) of the slide switch 10 to other vehicle components, such as whether the buckle mechanism 2 is engaged (e.g. in-use), or disengaged (e.g. not in-use).

The actuator 12 of the seat belt buckle mechanism 2 may slideably couple to the frame 9 and may be configured to slide in an actuator displacement direction 21 between the frame 9 and a portion of the cover 3. The actuator 12 includes a center portion 42 (FIG. 6) configured to be engaged and displaced by the tongue member 74 of the seat belt system 72 when the tongue member 74 is inserted through the aperture 6 of the cover 3. The tongue member 74, when inserted through the aperture 6 in the cover 3, contacts the actuator 12 so that further displacement of the tongue member 74 towards engagement with the latch member 1 of the buckle mechanism 2 displaces the actuator 12 in a substantially linear direction and substantially the same distance that the tongue member 74 travels.

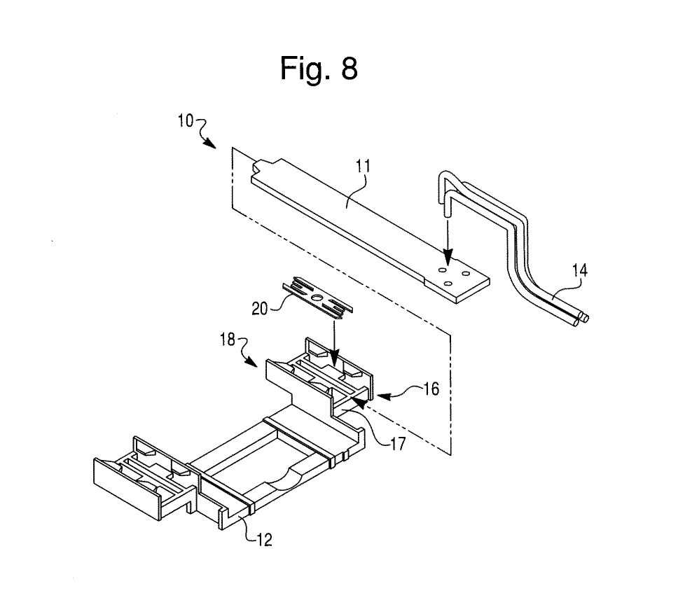

The actuator 12 includes a distal end 18 (FIG. 8) configured to include a carriage 17. The carriage 17 may retain a sliding member 20. The carriage 17 may be configured to displace the same distance and along the same direction as the actuator 12, so that displacement of the actuator 12 along the actuator displacement direction 21, for example by the tongue member 74, displaces the carriage 17 and hence the sliding member 20 retained by the carriage 17 substantially the same distance.

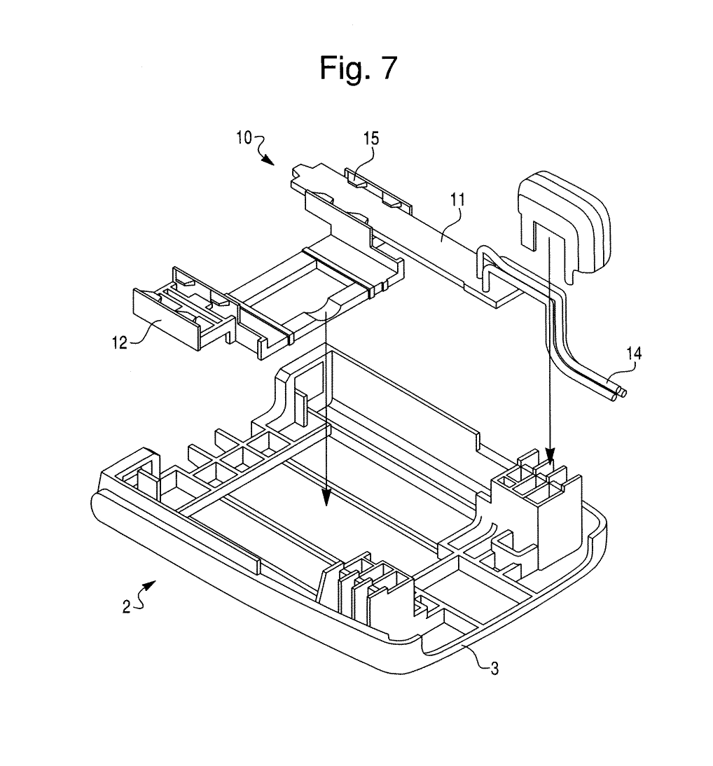

The carriage 17 may further be configured to include a pass through slot 16 (FIG. 8) having a plurality of ears or tabs 15 (FIG. 7), whereby the dielectric 11 of the slide switch 10 may reside in the pass through slot 16 and the plurality of ears 15 may guide and retain the carriage 17 to the dielectric 11 when the actuator 12 and carriage 17 displace relative to the dielectric 11 and the frame 9. For example, the dielectric 11 may be coupled to the frame 9 and/or the cover 3, such that displacement of the actuator 12 displaces the carriage 17 and the sliding member 20 relative to the dielectric 11 along the longitudinal length of the dielectric 11. Thus, displacement of the sliding member 20 by the actuator 12, relative to the dielectric 11, causes the switch position to change such as from a normally closed switch position to a normally open switch position.

The seat belt buckle mechanism 75 (FIG. 2) may also include an attachment mechanism 85 for coupling to another component of the vehicle, such as the seat system 72 or floor assembly. The attachment mechanism 85 may include an anchor member 76 or strap and an anchoring or coupling fastener. The anchor member 76 may be made of fabric (e.g., high strength nylon mesh) or any other useful material. The anchor member 76 may include a first end 81 for coupling to the seat belt buckle mechanism 75 and a second end 82 for fixing to another vehicle component (e.g. a seat cushion 80). The second end 82 may include an aperture that an anchoring fastener may pass through to fix the second end 82 of the anchor member 76 to the fixing component 80. The seat belt buckle mechanism 75 can be configured using other fixing mechanisms and may include other components, such as pretensioning devices. The second end 82 of the anchor member 76 may couple to the frame 9 of the seat belt buckle mechanism 75.

As shown in FIG. 4, the seat belt buckle mechanism 2 may further include a biasing member 19 (e.g., spring), which imparts a biasing force on the release button 4. The biasing force may keep the release button 4 in the position corresponding to the latch 1 and the tongue member 74 in the engaged position when there is no external force applied to the release button 4, such as a force applied by an occupant 79 to uncouple the tongue 74 and latch member 1.

The seat belt mechanism 2 described above may include the slide switch 10. The slide switch 10 may be configured so that the switch changes position based on whether the tongue of the seat belt is engaged and locked in the buckle. A slide switch may include a sliding member or contact member and a printed circuit board (“PCB”). The sliding member includes sliding contact members or first and second set of contacts and the PCB includes PCB contact members. The sliding member may move relative to the PCB. Alternately, both the sliding member and the PCB may move. The PCB may have three PCB contact members. The three PCB contact members are named based on the position of the slide switch when the PCB contact member is engaged (e.g. connects) or disengaged (e.g. breaks contact) with a corresponding contact on the sliding member. For example, the “normally closed” or “NC” contact is engaged with a corresponding contact on the sliding member when the slide switch is “closed.” The “normally open” or “NO” contact is engaged with a corresponding contact on the sliding member when the slide switch is “open.” The “common” or “COM” contact is engaged with a corresponding contact on the sliding member when the slide switch is “grounded.”

A slide switch may be configured to include a PCB with multiple contacts or printed circuit board contact members and a contact member or sliding member with sliding contact members where some sliding contact members are configured for high current conditions and other sliding contact members are configured for low current conditions. The different sets of sliding contact members may be integrally formed with the printed circuit board contact member and therefore electrically the same, so that the slide switch communicates electrically to a single electronic device (e.g., usage indicator, control module) in the vehicle. Some sliding contact members may be configured with a relative higher durability (e.g., wear-resistant) contact material to accept and withstand a relative high electrical arc and to conduct high currents. These sliding contact members may further be configured to engage a PCB contact member of the PCB prior to or disengage from a PCB contact member of the PCB after the other sliding contact members, in order to accept the electrical arc. The other sliding contact members may not accept an electrical arc and may be configured with a relative higher conductivity contact material to conduct low currents. The slide switch may be configured so that the sliding member displaces relative to the PCB, which may move the sliding contact members into or out of engagement with any of the PCB contact members. Thus, the slide switch may be configured to undergo and withstand high arcing through some sliding contact members, and to conduct relative low currents through other sliding contact members. The contact material and spring force for each sliding contact member of the sliding member can be tailored to meet varying requirements.

Alternately, a slide switch may be configured to include a PCB with PCB contact members and a sliding member with some sliding contact members configured for high current conditions and other sliding contact members configured for low current conditions. The sliding contact members may be formed in the sliding member to be electrically different, so that the slide switch can communicate electrically to more than one electronic device (e.g., usage indicator, control module) in the vehicle. For example, the slide switch may be configured for use in a buckle mechanism, whereby some of the sliding contact members may provide a relative high resistance path to communicate electrically to a first electronic device and the other sliding contact members may provide a relative low resistance path to communicate electrically to a second electronic device.

A slide switch of the seat belt buckle mechanism may be configured to include a high current path, which may be used to alert the driver of the vehicle as to usage or non-usage of safety belts via an illuminated dashboard light or indicator, and a low current path, which may be used to communicate belt usage to an electronic restraint controller or control module. The control module may receive information from seat occupant sensors and the safety belt system to determine whether an airbag, such as a passenger airbag, should be deployed during a dynamic vehicle impact, or may communicate to a pretensioner coupled to the buckle mechanism of the seat belt system, and determine whether to fire based on the communication from the buckle mechanism. For example, the slide switch may be configured so that some sliding contact members conduct high current and the other sliding contact members conduct low current. For example, the slide switch may be configured so that the normally open (N-O) PCB contact member functions as a high current path, while the normally closed (N-C) PCB contact member functions as a low current path. For another example, the slide switch may be configured with both the normally open and normally closed PCB contact members having high and/or low current paths.

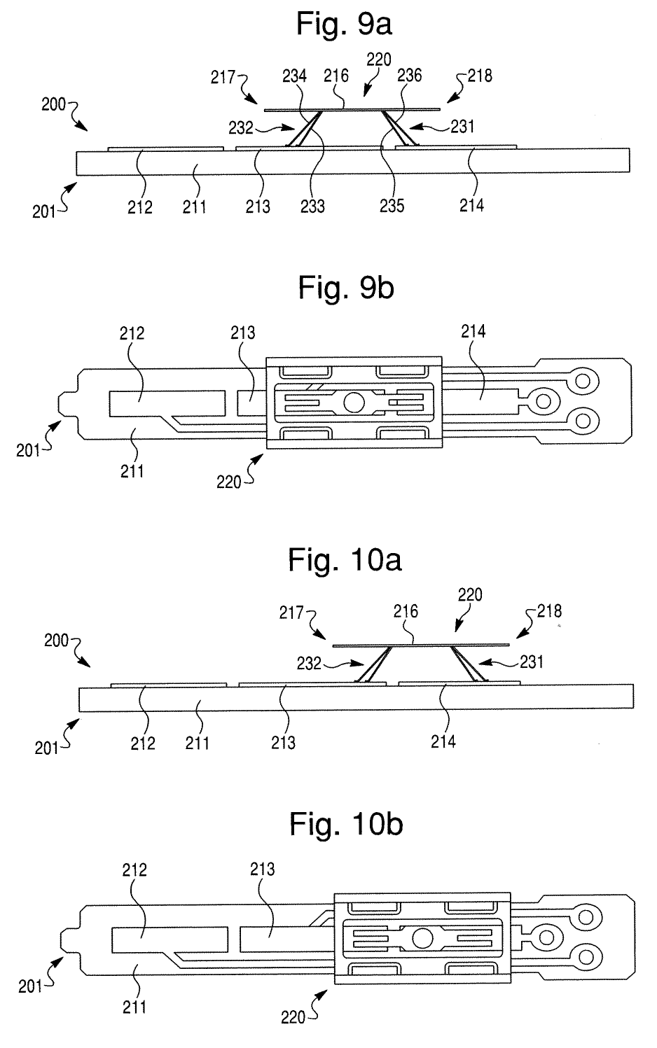

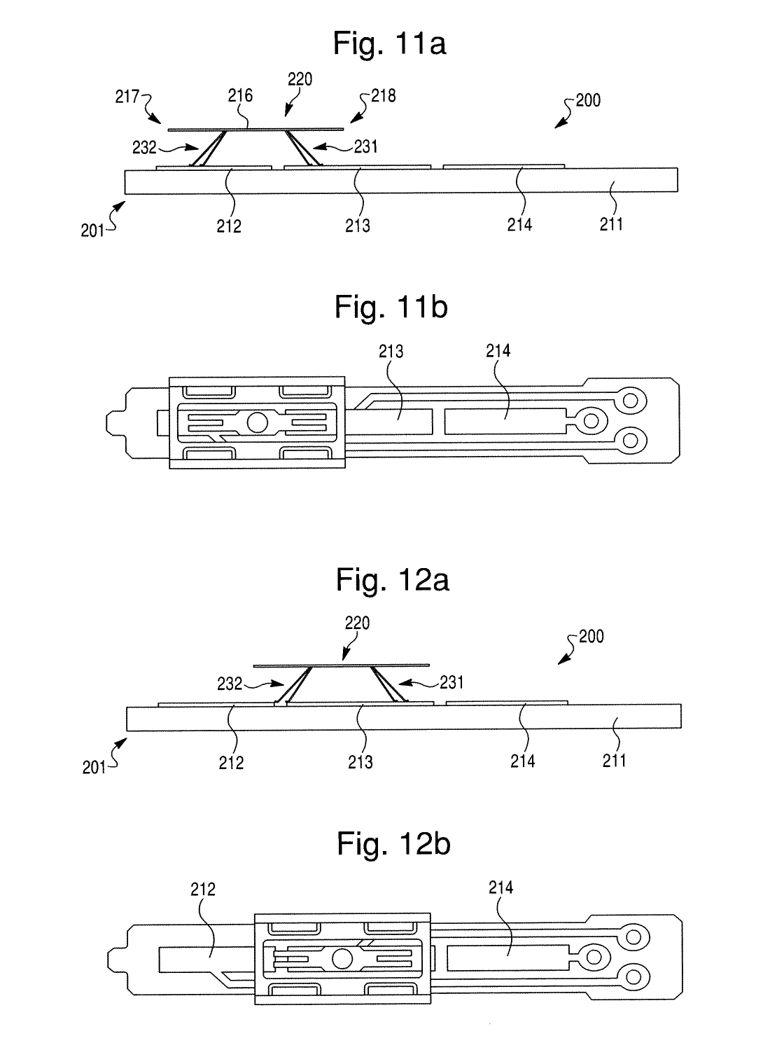

In general, as shown in FIGS. 9a-17e, a sliding switch 200, 300, 400, 500 includes a sliding member or slide switch contact member 220, 320, 420, 520, etc. configured to slide between a first position and a second position and a PCB 201, 301, 401, 501. The sliding member 220, 320, 420, 520 includes a first sliding contact member 233, 433, 533 and a second sliding contact member 234, 434, 534. The PCB 201, 301, 401, 501 includes a first PCB 212, 312, 512 that contacts both the first and second sliding contact members 233, 433, 533, 234, 434, 534 when the sliding member 220, 320, 420, 520 is in the first position (FIGS. 11a-11b). When the sliding member 220, 320, 420, 520 moves from the first position to the second position the first sliding contact member 233, 433, 533 is configured to break (e.g. disengage) contact with the first PCB contact member 212, 312, 512 before the second sliding contact member 234, 434, 534. In the second position (FIGS. 10a-10b), neither the first nor second sliding contact members 233, 433, 533, 234, 434, 534 are in contact with the first PCB contact member 212, 312, 512.

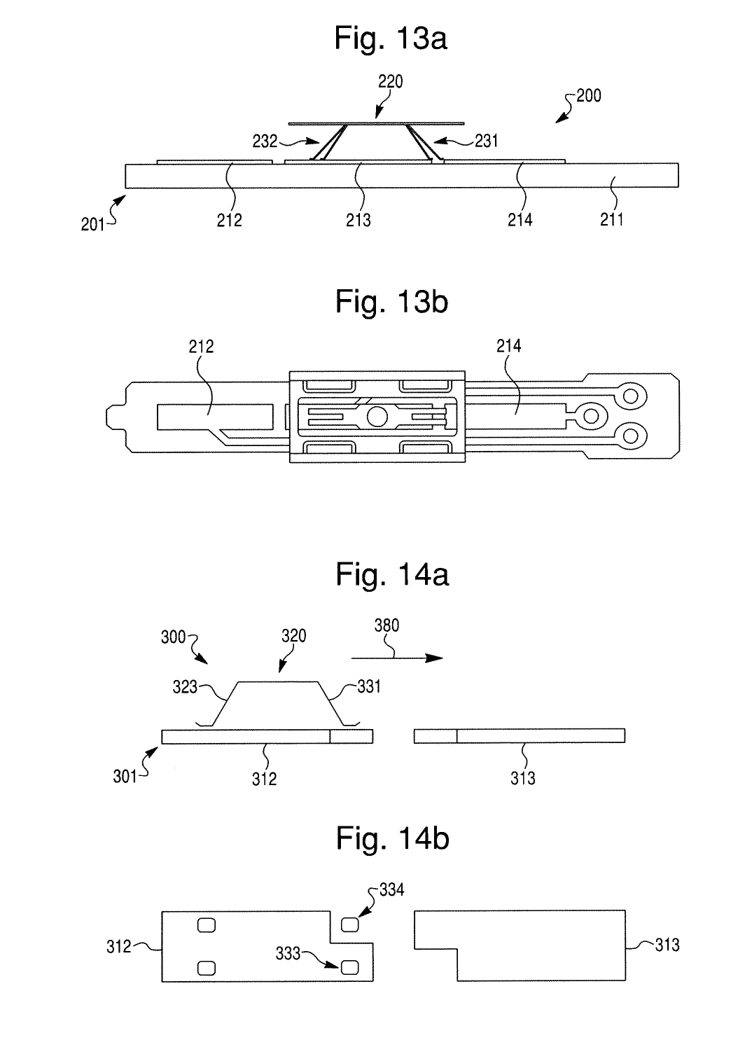

FIGS. 11a-11b show the sliding member 220 in the first position. FIGS. 10a-10b show the sliding member 220 in the second position. The succession of the sliding member 220 moving from the first position to the second position is shown from FIGS. 11a-11b, to FIGS. 12a-12b, to FIGS. 13a-13b, to FIGS. 9a-9b and then to FIGS. 10a-10b. FIGS. The reverse is true for the succession of the sliding member 220 moving from the second position to the first position. When the sliding member 220 is in the first position none of the sliding contact members 233, 234, 235, 236 contact the second sliding contact member 214. When the sliding member 220 is in the second position neither the first nor second sliding contact members 233, 234 contact the second PCB contact member 214. Moreover, when the sliding member 220 moves from the second position to the first position the second sliding contact member 234 is configured to contact the first PCB contact member 212 before the first sliding contact member 233. When the sliding member 220 moves from the first position to the second position the fourth sliding contact member 236 is configured to contact the second PCB contact member 214 before the third sliding contact member 235. When the sliding member moves from the second position to the first position the third sliding contact member 235 is configured to break contact from the second PCB contact member 214 before the fourth sliding contact member 236.

With reference to FIGS. 9a-13b, an exemplary slide switch is illustrated. The slide switch 200 may include a slide switch contact member or contact member or sliding member 220 and a PCB 201. The sliding member 220 may include a first set of sliding contact members 231 and a second set of sliding contact members 232 and is configured to conduct low and high current. Additionally, the sliding member 220 may include a base 216 having a first end 217 and a second end 218 where the first and second set of sliding contact members 231, 232 at least one of connect to and extend from the base 216.

The first set of sliding contact members 231 includes a third sliding contact member or a first wiping contact 235 and a second wiping contact or fourth sliding contact member 236 and the second set of sliding contact members 232 includes a third wiping contact or first sliding contact member 233 and a fourth wiping contact or second sliding contact member 234. The sliding contact members 233, 234, 235, 236 of each of the first and second set of sliding contact members 231, 232 may be integrally formed, as shown, and therefore electrically the same, so that the sliding contact members communicate with the same electronic device electrically coupled to the slide switch 200. The second and fourth sliding contact members 234, 236 may accept an electrical arc and may be configured to conduct relatively high currents. The contact surfaces of the second and fourth sliding contact members 234, 236 may be made from a relatively high durability (e.g., wear-resistant) material, such as platinum-tungsten, to permit second and fourth life (e.g., high number of switching between different contacts) of the contact even when subjected to repeated high arc and high current conditions. The first and third sliding contact members 233, 235 may not accept an electrical arc and may be configured to conduct relatively low currents. The contact surfaces of the first and third sliding contact members 233, 235 may be made from relatively high conductive materials (e.g., gold). The second and fourth sliding contact members 234, 236 may longer than each of the first and third sliding contact members 233, 235.

The PCB 201 may include at least one insulating or dielectric layer 211, a normally closed (N-C) contact or first PCB contact member 212, a common (COM) contact or third PCB contact member 213, and a normally open (N-O) contact or second PCB contact member 214. The dielectric 211 may be made of any conventional prepeg material, and made preferably from FR3 (or cotton paper and epoxy) or FR4 (woven glass and epoxy). The PCB contact members 212, 213, 214 may be made from any suitable conducting material (e.g., thin copper foil) and manufactured through any suitable method. According to an exemplary embodiment, the PCB contact members 212, 213, 214 may be made to include a base layer made from thin copper foil, a flash layer configured to cover the base layer made from nickel, and a thin coating layer configured to cover the flash layer made from a noble metal (e.g., gold). The PCB contact members interact with the first and second set of sliding contact members 231, 232 of the sliding member 220.

The second and fourth sliding contact members 234, 236 may be configured to engage a PCB contact member (e.g., N-O) prior to the adjacent first and third sliding contact members 233, 235, to allow the electrical arc to form between the second and fourth sliding contact member 234, 236 and the PCB 201 contact, so that first and third sliding contact member 233, 235 engage the contact of the PCB 201 without an electrical arc, since the electrical connection is already formed between the second and fourth sliding contact member 234, 236 and PCB contact member 212, 213, 214. Additionally, the first and third sliding contact members 233, 235 may be configured to disengage from a PCB contact member 212, 213, 214 prior to the adjacent second and fourth sliding contact member 234, 236, so that there is no electrical arc formed between the PCB contact member 212, 213, 214 and first and third sliding contact member 233, 235, since the second and fourth sliding contact member 234, 236 and PCB contact members 212, 213, 214 remain in contact.

The slide switch 200 is shown in FIGS. 9a-10b with the sliding member 220 configured with the first set of sliding contact members 231 or first wiping contact 231 in the closed position (i.e., in contact) with the second PCB contact member 214 and with the second set of sliding contact members 232 or second wiping contact 232 in the closed position with the third PCB contact member 213, which corresponds to the tongue member coupled to or engaging the latch member of the buckle mechanism. In FIGS. 10a-10b, the slide switch 200 is shown in a position corresponding to the full engagement between the tongue member and latch member, or the full stroke position of the tongue member relative to the buckle mechanism.

The slide switch 200 is shown in FIGS. 11a-11b with the sliding member 220 configured with the first set of sliding contact members 231 in the closed position with the third PCB contact member 213 and with the second set of sliding contact members 232 in the closed position with the first PCB contact member 212, which corresponds to the tongue member not engaged (or decoupled) from the latch member of the buckle mechanism.

The slide switch 200 is shown in FIGS. 12a-12b with the first set of sliding contact members 231 in the closed position with the third PCB contact member 213 and with the second set of sliding contact members 232 in an open position, whereby the second set of sliding contact members 232 is in contact with the dielectric and between the first and third PCB contact members 212, 213, which corresponds to the switch change over point on the N-C side.

The slide switch 200 is shown in FIGS. 13a-13b with the second set of sliding contact members 232 in the closed position with the third sliding contact member 213 of the PCB 201 and with the first set of sliding contact members 231 in an open position contacting the dielectric 211 and between the third and second PCB contact members 213, 214, which corresponds to the switch change over point on the N-O side. When the slide switch 200 is configured in these positions, the PCB 201 may communicate to an indicator lamp and/or a control module or other device, such as a safety device, as to the seat belt being configured in the non-use (i.e., unbuckled) position.

The above-mentioned configuration of the contact member 220 allows the slide switch 200 to withstand repeated relative high electrical arcs and to conduct repeated relative high currents through the second and fourth sliding contact members 234, 236, and further allows the slide switch 200 to conduct repeated relative low currents through the first and third sliding contact members 233, 235. This allows the low current contact surfaces of the first and third sliding contact members 233, 235 to avoid wear by being subjected to low currents and low contact forces. Thus, the slide switch 200 may operate for a relative second and fourth life (i.e. high number of operating cycles) optimally under different operating conditions or different types of circuitry, while configured with a single sliding member 220.

With reference to FIGS. 14a-14b, another exemplary slide switch 300 is illustrated. The slide switch 300 includes a sliding member 320 and a PCB 301. The sliding member 320 includes a first set of sliding contact members 331 including third and fourth sliding contact members and a second set of sliding contact members 332 including first and second sliding contact members.

The first and second sliding contact members 331, 332 may include two (or more) substantially adjacent sliding contact members configured to be substantially equal in length (FIG. 14a). One sliding contact member from each of the first and second set of sliding contact members 331, 332 maybe configured for high durability and high currents, while the other adjacent set of sliding contact members may be configured with high conductivity contact surfaces to conduct low currents. The PCB 301 may include a first contact 312, such as a N-O contact or first PCB contact member 312, and a second contact, such as a COM contact 313 or third PCB contact member, in which the PCB 301 contacts 312, 313 may vary in shape (FIG. 14b). For example, the shape of the first and third PCB contact members 312, 313 may be z-shaped or diagonally shaped. As shown in FIG. 14b, the PCB contact members are L-shaped. The PCB may also include a second PCB contact member such as a N-C contact.

The third PCB contact member 313 may be configured to have a shape that permits the second sliding contact member 334 from disengaging (or breaking contact from) the third PCB contact member 313 after the first sliding contact member 333, when the contact member 320 slides in the direction opposite the direction 380 shown in FIG. 14a relative to the PCB 301. The third PCB contact member 313 may further be configured to have a shape that permits the second sliding contact member 334 to engage (or connect) the third PCB contact member 313 prior to the first sliding contact member 333, when the contact member 320 slides in the switch contact travel direction 380 (FIG. 14a) relative to the PCB 301. Thus, the first and third PCB contact members 312, 313 may be configured for use with substantially equal length sliding contact members to allow the slide switch 300 to have the second sliding contact member 334 configured to accept an electric arc and to conduct high currents, and to have the first sliding contact member 333 configured not to accept an electric arc and to conduct low currents. The first PCB contact member 312 may be configured to have a shape which allows one sliding contact member to accept an electric arc and to conduct high currents, while allowing a different sliding contact member to not accept an electric arc and to conduct low currents.

Additionally, the PCB 301 may be configured to include any number of contacts, in which any one, all, or any combination of the contacts may vary in configuration to permit the first and second set of sliding contact members 331, 332 of the sliding member 320 to be configured differently, such as to permit one sliding contact member to accept electric arcs and to conduct high currents, while another sliding contact member may conduct low currents and receive no electric arc. Those skilled in the art will recognize that the illustrations disclosed herein are not meant as limitations, and that the sliding contact members and/or the PCB contacts may be tailored to varying requirements.

The slide switch may be configured to include a sliding member with sliding contact members, which may be formed to be electrically different, and a PCB. The PCB has multiple PCB contact members. Some of the sliding contact members or contact members may be configured to accept electric arcs and to conduct relative high currents. The other sliding contact members or contact members may be configured to conduct low currents. The sliding contact members may be formed in the sliding member to be electrically different, so that the slide switch may communicate with a first electronic device through some of the sliding contact members and may communicate with a second electronic device through the rest of the sliding contact members. For example, the slide switch may communicate through some of the sliding contact members to an indicator lamp, which may be located on the dashboard of the vehicle, to indicate the seat belt is configured in the use (i.e., buckled) position; and the slide switch may further communicate through the other sliding contact members to a control module or other device, such as a safety device (e.g., a buckle pretensioner, airbag), as to the seat belt being configured in the use position.

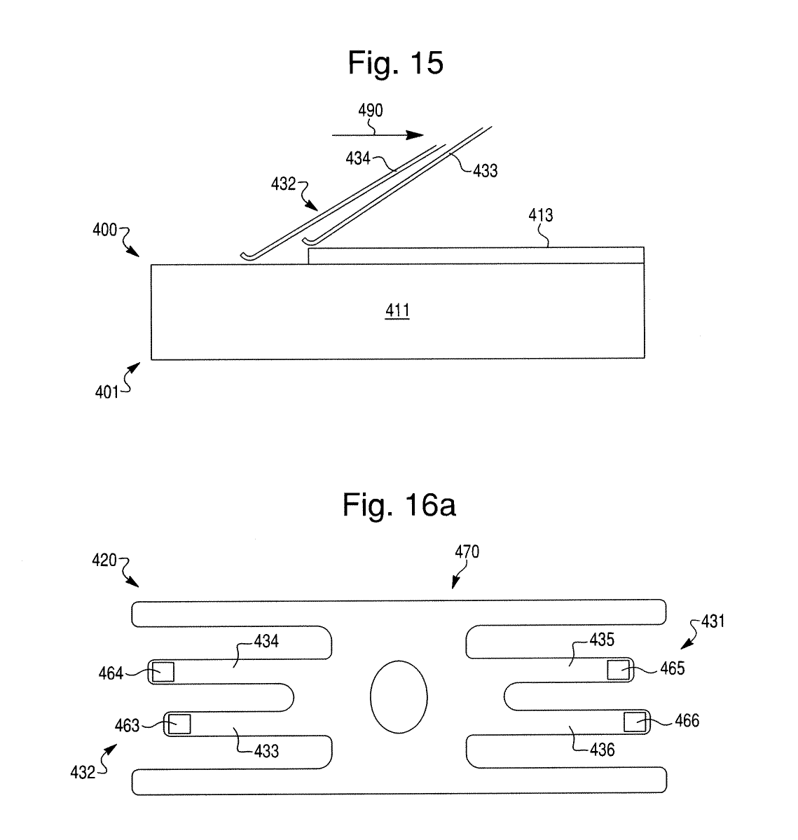

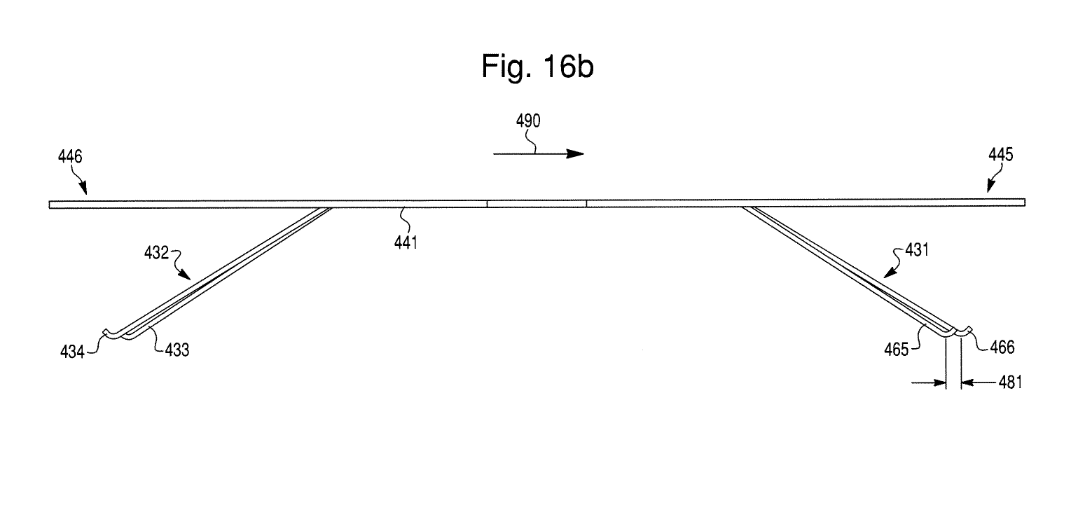

FIGS. 15-16b show an exemplary sliding member 420. The sliding member 420 may be configured to include a base 441, a first set of sliding contact members 431 and a second set of sliding contact members 432. The base 441 (FIG. 16b) may be a thin sheet made of any suitable conductive material (e.g., copper, copper-tin alloy). For example, the base 441 may be a copper-tin layer covered by a flash layer of nickel to improve adherence of the coating layer and to improve durability. The flash layer may be made from other suitable materials. The first and second set of sliding contact members 431, 432 may be formed out of the thin base 441, and may take the form of thin legs that extend at an angle offset from the base 431 in the direction towards the PCB 401 (FIG. 16). For example, the first set of sliding contact members 431 may be formed out of the first end 445 of the contact member 420 and the second set of sliding contact members 432 may be formed out of the second end 446 of the contact member 420. Alternatively, the set of sliding contact members 431, 432 may be formed separate to and coupled to the base 441.

The first set of sliding contact members 431 may include a third and fourth sliding contact member 435, 436 and the second set of sliding contact members 432 may include a first and second sliding contact member 433, 434 (FIGS. 15 and 16b), whereby the fourth sliding contact member 436 may extend farther from the base than the third sliding contact member 435. Alternatively, the sliding contact members of each of the first and second set of contact members 331, 332 (FIG. 14a) may have substantially equal lengths.

The set of sliding contact members 431, 432 may include a curved end, forming a contact terminal 463, 464, 465, 466, which may be configured to include a coating to improve conductivity or durability. The set of sliding contact members 431, 432 may be flexible and may be configured to bias the set of sliding contact members 431, 432 in a position to improve contact with the PCB 401, whereby each set of sliding contact member 431, 432 imparts a force from the contact terminal 463, 464, 465, 466 onto the PCB 401 (e.g., contact, dielectric) at the point of contact. This bias helps improve the electrical conductance of the circuit or PCB 401 by maintaining a proper contact force. The level of bias (i.e., the spring force imparted) may be controlled to avoid inducing excessive wear from increased friction between the contact terminals 463, 464, 465, 466 of the set of sliding contact members 431, 432 and the PCB 401.

The contact terminals 463, 464, 465, 466 (FIGS. 16a-16b) of the sliding contact members 433, 434, 435, 436 may be configured similarly to include the same coating. Alternatively, the contact terminals 463, 465 of the first and third sliding contact members 433, 435 may be configured to include a unique coating relative to the contact terminals 464, 466 of the second and fourth sliding contact members 434, 436. For example, the contact terminal 464, 466 on the second and fourth sliding contact member 434, 436 may be configured to conduct a relative high current or high resistance, such as 400 mA or 20Ω, and to improve durability may include a coating comprising a relatively high durability material, which may be formed over the nickel flash layer of the contact member 420, and the contact terminal 463, 465 on the first and third sliding contact members 433, 435 may be configured to conduct a relative low current or low resistance, such as 1 mA, and for improved conductivity may include a plating 470 (FIG. 16a) comprising one or more noble metals (e.g., gold, silver, platinum, rhodium, etc.).

The sliding member 420 may be configured to include different length contacts with different conductive coatings to allow the slide switch 400 to operate under opposing and normally exclusive operating conditions. For example, a slide switch 400 for use in an automotive safety buckle mechanism may pass relatively large currents into inductive lamps to illuminate the lamp to alert a vehicle occupant as to seat belt usage by an occupant. These large current contacts, such as for lamp switches, must survive arcing and maintain moderate contact resistance through the life of the product. Thus, the contacts for the large currents typically have contact terminals configured for durability, such as nickel plating, since contact terminals comprising of gold (or other similar materials) can be damaged by relative high inductive loads, typically at currents greater than 50 mA. The contact terminals for low current and low voltage applications may be configured using noble metals (e.g., gold) to maintain low resistance for improved conductivity. The noble metals are also suitable for the low resistance applications due to the low contact forces do not cause excessive wear. Those skilled in the art will recognize that the sliding contact members as disclosed herein may be configured to improve performance (e.g., electrical conductance) or durability of the circuit, and may be tailored to meet specific customer requirements for varying conditions.

The contact member may be configured to include a spacing 481 in the sliding direction 490 (FIG. 16b) between the contact terminal of the second and fourth sliding contact members and contact terminal of the first and third sliding contact members. The spacing 481 may be configured to fit between the traces of the PCB contact members, and may further be configured to allow the first and third sliding contact member to be clear of a contaminant zone prior to the second and fourth sliding contact member contacting the zone. The contaminant zone is the portion of the PCB contact member (e.g., N-C, N-O, COM) beginning with the leading edge of contact with the sliding contact members that is contaminated by both debris and particulates that the sliding contact members pick up from the dielectric layer and wipe onto the contacts and arcing between the sliding contact members of the sliding member and the PCB contact members. The contaminated zone can have a substantially reduced conductance relative to the portion of the contact following the contaminated zone. Additionally, a relative soft coating, such as gold, can be damaged from this arcing.

The configuration of sliding contact members disclosed herein prevents contamination and wear on the low resistance circuit, which results in improved conductance at the contacts with improved life of the circuit. Those skilled in the art will recognize that the spacing and geometry of the area between contact terminals may be tailored to meet varying requirements and conditions. Those skilled in the art will also recognize that the contact paths of the PCB can be optimized to allow space for double contacts on the contact surface of the PCB between traces, for a slide switch configured with a contact member having two sets of sliding contact members.

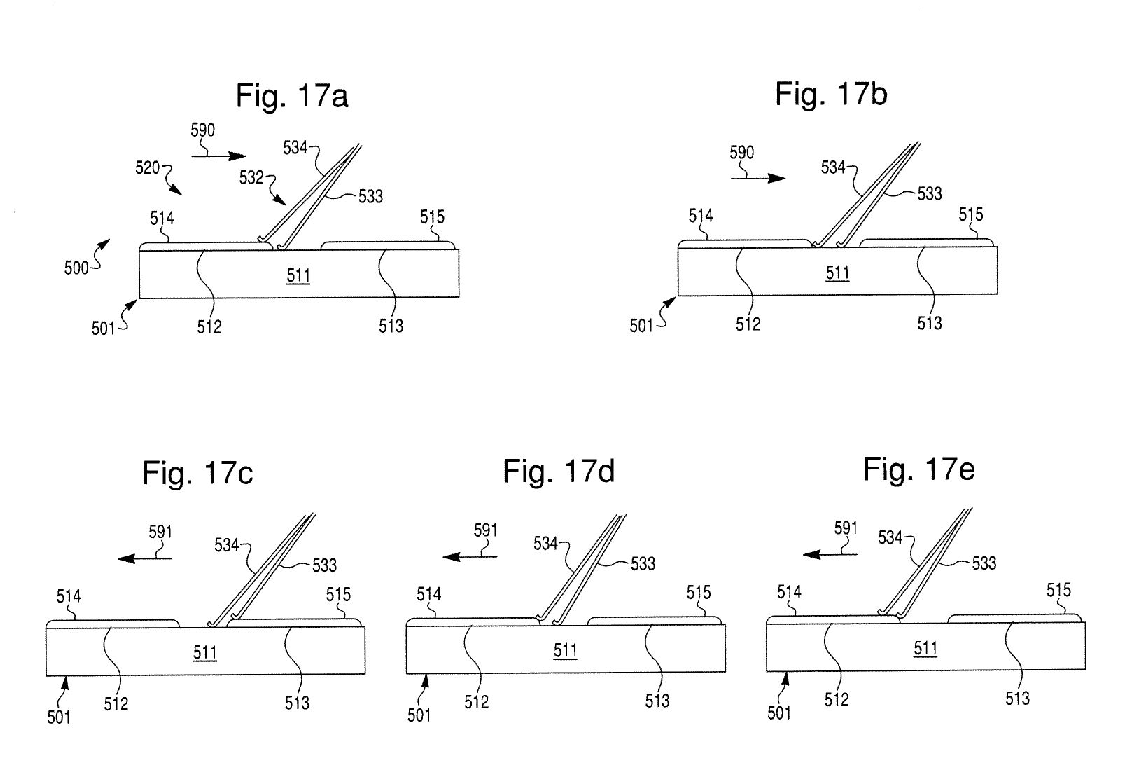

With reference to FIGS. 17a-17e, partial detail views illustrate the positions of the first and second sliding contact members 533, 534 as the sliding member 520 slides relative to the PCB 501. FIGS. 17a-17b illustrate the sliding member 520 sliding in the latching longitudinal direction 590 relative to the PCB 501, which corresponds to the tongue member being engaged or coupled with the latch member of the buckle mechanism. This displacement of the tongue member into engagement with the latch member provides the relative translation or displacement of the sliding contact members of the slide switch 500 relative to the PCB 501, which includes the PCB contact members 512, 513 (e.g. N-O, N-C, and COM) contacts, thus driving the contact configuration between the sliding contact members 533, 534 and the PCB contact members 512, 513 or dielectric 511. FIGS. 17c-17e illustrate the sliding member 520 sliding in the unlatching direction 591 relative to the PCB 501, which corresponds to the tongue member being disengaged or decoupled with the latch member of the buckle mechanism. The PCB 501 may be configured so that the first PCB contact member 512 (e.g. N-C contact) has a 14 V potential 514 and the third PCB contact member 513 (e.g. COM contact) has a 0 (zero) V potential 515 or may be ground 515.

The contact member may displace in the latching longitudinal direction 590 relative to the PCB 501, during latching of the tongue member to the latch member. During the latching displacement of the contact member, the sliding contact members move from contacting the first PCB contact member to contacting the dielectric. As shown in FIG. 17a, the first sliding contact member 533 breaks contact with the first PCB contact member 512 first without a switching arc, whereby the first sliding contact member 533 contacts the dielectric 511 while the second sliding contact member 534 contacts the first PCB contact member 512. As shown in FIG. 17b, continued displacement of the contact member 520 in the latching longitudinal direction 590 relative to the PCB 501, may allow the second sliding contact member 534 to break contact with the first PCB contact member 512 last to contact the dielectric 511, which produces a full switching arc between the second sliding contact member 534 and the N first PCB contact member 512, while the first sliding contact member 533 may remain in contact with the dielectric 511.

The contact member may displace in the unlatching longitudinal direction 591 relative to the PCB 501, during unlatching of the tongue member from the latch member of the buckle mechanism. During the unlatching displacement of the contact member 532, the second sliding contact member 534 moves from contacting the third PCB contact member to contacting the dielectric. As shown in FIG. 17c, the second sliding contact member 534 breaks contact with the third PCB contact member 513 first without a switching arc, since the third PCB contact member 513 may have zero volt potential 515. Continued displacement of the contact member 520 in the unlatching longitudinal direction 591 may allow the first sliding contact member 533 to break contact with the third PCB contact member 513, whereby both the first and second sliding contact members 533, 534 may contact the dielectric 511. As shown in FIG. 17d, continued displacement of the sliding member 520 in the unlatching longitudinal direction 591 may allow the second sliding contact member 533 to contact the first PCB contact member 512 prior to the first sliding contact member or third wiping contact 533, whereby the second sliding contact member or fourth wiping contact 534 has 14 V potential 514 and may have a full switching arc. As shown in FIG. 17e, continued displacement of the sliding member or contact member 520 in the unlatching longitudinal direction 591 may allow the first sliding contact member 533 to contact the first PCB contact member 512 subsequent to the second sliding contact member 534, whereby the first sliding contact member 533 has no switching arc upon transition from the zero volt potential 515 dielectric 511.

With reference to FIGS. 17a-17e, the sliding member 520 may control the switching arcs to pass through the second sliding contact members 534. This configuration allows the first sliding contact members 533 to include contact terminals made from noble metals, which can be damaged from high current switching, to provide efficient low current switching and improved conductivity for use with safety and restraint modules, controllers and devices. This configuration further allows the second sliding contact members 534 to include contact terminals made from more durable and less expensive materials, such as nickel electroplate over the copper-tin contact member. The second sliding contact members 534 may be configured to provide durable second and fourth life switching of high currents, such as high inductive loads produced by inductive lamps that illuminate on a vehicle dashboard.

Those skilled in the art will recognize that the contact members disclosed herein may be configured to include at least two sets of contacts, whereby each contact set operates within a different and normally opposing condition. Therefore the slide switches configured to include such contact members provide improved performance by communicating to both high and low current devices, and are optimized in cost and durability. Those skilled in the art will recognize that the slide switches configured to include contact members as disclosed are not limited to the use as disclosed herein and may be used on other suitable electro-mechanical devices.

As utilized herein, the terms “approximately,” “about,” “substantially”, and similar terms are intended to have a broad meaning in harmony with the common and accepted usage by those of ordinary skill in the art to which the subject matter of this application pertains. It should be understood by those of skill in the art who review this application that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present application.

It is important to note that the construction and arrangement of the slide switches as shown in the various exemplary embodiments are illustrative only. Although only a few embodiments have been described in detail in this application, those skilled in the art who review this application will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A seat belt system for use in a motor vehicle, comprising:
a tongue member;
a latch member for detachably engaging the tongue member;
a release member for releasing engagement between the tongue member and the latch member;
a slide switch configured to communicate whether the tongue member is engaged with the latch member, wherein the slide switch includes:
a sliding member configured to slide between first and second positions;
a printed circuit board;
wherein the sliding member includes a first sliding contact member and a second sliding contact member,
wherein the printed circuit board includes a first printed circuit board contact member that contacts both the first and second sliding contact members when the sliding member is in the first position, and
wherein when the sliding member moves from the first position to the second position the first sliding contact member is configured to break contact with the first printed circuit board contact member before the second sliding contact member.

2. The seat belt system of claim 1, wherein neither the first nor second sliding contact members are in contact with the first printed board contact member when the sliding member is in the second position.

3. The seat belt system of claim 2, wherein when the sliding member moves from the second position to the first position the second sliding contact member is configured to contact the first printed circuit board contact member before the first sliding contact member.

4. The seat belt system of claim 1, wherein the sliding member further includes a third sliding contact member and a fourth sliding contact member.

5. The seat belt system of claim 4, wherein the printed circuit board further includes a second printed circuit board contact member and wherein neither the first, second, third nor fourth contact members contact the second printed circuit board contact member when the sliding member is in the first position.

6. The seat belt system of claim 5, wherein when the sliding member moves from the first position to the second position the fourth sliding contact member is configured to contact the second printed circuit board contact member before the third sliding contact member.

7. The seat belt system of claim 5, wherein the third and fourth contact members contact the second printed circuit board contact member when the sliding member is in the second position.

8. The seat belt system of claim 5, wherein when the sliding member moves from the second position to the first position the third sliding contact member is configured to break contact from the second printed circuit board contact member before the fourth sliding contact member.

9. The seat belt system of claim 5, wherein neither the first nor second sliding contact members are in contact with the second printed circuit board member when the sliding member is in the second position.

10. The seat belt system of claim 1, wherein the first sliding contact member is shorter than the second sliding contact member.

11. The seat belt system of claim 4, wherein the third sliding contact member is shorter than the fourth sliding contact member.

12. The seat belt system of claim 1, wherein the first and second sliding contact members are approximately the same length.

13. The slide switch of claim 4, wherein the third and fourth sliding contact members are approximately the same length.

14. The seat belt system of claim 5, wherein a shape of the first, second and third printed circuit board contact members differ from one another.
